(19) United States
(12) Patent Application Publication
(10) Pub. No.: US 2016/0297718 A1
(43) Pub. Date: Oct. 13, 2016

(54) PROCESS FOR METAL COATING OF INORGANIC PARTICLES BY MEANS OF CURRENTLESS METAL DEPOSITION

(71) Applicant: TECHNISCHE UNIVERSITÄT DRESDEN, Dresden (DE)

(72) Inventors: Giovanni MONDIN, Malo (Vi) (IT); Florian WISSER, St. Ingbert (DE); Susanne DÖRFLER, Dresden (DE); Stefan KASKEL, Dresden (DE)

(73) Assignee: TECHNISCHE UNIVERSITÄT DRESDEN, Dresden (DE)

(21) Appl. No.: 15/100,613

(22) PCT Filed: Nov. 27, 2014
(86) PCT No.: PCT/EP2014/075843

§ 371 Date: May 31, 2016

(30) Foreign Application Priority Data
Nov. 29, 2013 (DE) 10 2013 224 577.7

(51) Int. Cl. C04B 41/88; C22C 30/00; C04B 41/82

(52) U.S. Cl. CPC C04B 41/88; C04B 41/82; C22C 30/00

(57) ABSTRACT

The invention relates to a process for producing metal-coated inorganic particles by means of currentless deposition technique in which the inorganic particles are first functionalized, then introduced into an aqueous metal-salt solution containing metal ions, and the metal is reduced by adding a reducing agent to the aqueous metal-salt mixture containing the functionalized particles and the metal is deposited on the functionalized particles, wherein the functionalization of the inorganic particles takes place by means of aminophosphonic acids, aminocarboxylic acids and/or aminoalcohol phosphoric acid esters, and the aminophosphonic acid, the aminocarboxylic acid and/or the aminoalcohol phosphoric acid ester form(s) a monolayer on the surface of the inorganic particles. The metal-coated inorganic particles can be introduced into metal matrices due to their improved surface properties.

The invention describes metal-coated inorganic particles and a process for producing same by means of currentless metal deposition. The metal-coated inorganic particles can be introduced into metal molds due to their improved surface properties.

Current processes of deposition of metals on the surface of particles also include chemical processes, such as currentless deposition in addition to the expensive and complicated physical deposition processes such as PVD (physical vapor deposition) and sputtering. Chemical deposition processes are simpler and more favorable and make it possible to produce homogenous/conforming metal layers. The previous wet chemical processes are based on so-called noble metal particle seeding in which expensive precursors are used and which result in heavy metal waste (e.g., Sn and Pd waste). In addition, the surface of the species to be coated must first be activated for the metal which is to be applied to the surface not to be precipitated as independent metal particles in parallel with the particles. It is also a disadvantage that with the help of this process no homogenous/conformal metal layer is created on the nanoparticles after metal deposition but instead only particulate morphologies are obtained. The surface properties of the particles obtained in this way are not similar enough to those of the matrix accordingly so that when they are introduced into the metal matrix, there is a high probability of separation or agglomeration of the particles [S. S. Djokić, Electroless deposition of metals and alloys, in B. E. Conway, R. E. White (Eds.), Modern Aspects of Electrochemistry, vol. 35, Springer, US 2002, pp. 51-133; Z. Deng et al., J. Phys. chem. C2007, 111, 11692; R. L. Cohen et al., J. Electrochem. Soc. 1973, 120, 502].

J. Samuel et al. describe a process for producing metal clusters on SiO₂ nanoparticles by automatic reduction. The deposition of metal clusters would take place only when the SiO₂ nanoparticles had been modified with both amino groups and thiol groups [Mater. Res Soc. Symp. Proc. 1207: 103-108].

US 2002/0132045 A1 and US 2003/0164064 A1 disclose processes for producing a metal nano-shell on specially functionalized SiO₂ nanoparticles. US 2003/0118657 discloses the use of such functionalized nanoparticles to reduce or prevent the regeneration of new blood vessels (vascularization). EP 1 936 378 A1 discloses multilayer nanoparticles having a magnetic core surrounded by an SiO₂ layer, which in turn is surrounded by a layer of gold and optionally additional metal layers. Biosensor molecules (such as aptemers) are immobilized on the nanoparticles as an outer layer. The metal layer is produced in these documents, in which the silicate surface is first functionalized with an amino silane linker and gold colloid particles are next bound to it. Then other metals can be reductively deposited on the surface modified in this way.

WO 2012/072658 A2 discloses a process for metal coating of nanoparticles by means of currentless deposition techniques. In particular homogenous metal-coated nanoparticles are suitable for use as fillers in metal-matrix composites, wherein the deposited metal layer functions as a dispersion mediator between nonmetallic nanoparticles and the metal matrix.

The process for producing nanoparticles for currentless metal deposition comprises the steps: a) thiol functionalization of the surface of the nanoparticles, b) bringing the nanoparticles in contact with an aqueous metal salt solution, c) adding a reducing agent, which reduces the metal-salt solution, so that metal is deposited on the nanoparticles.

In the case of oxidic particles, carbides and other ceramic particles, thiol functionalization takes place by means of a mercaptoorganylsilane, or in the case of carbon particles, thiol functionalization takes place by means of a thiol, phosphorus pentasulfide, mercaptoorganylsilane, H₂S or CS₂.

One disadvantage of the process for metal coating of nanoparticles by means of currentless deposition techniques is the functionalization of the surface by means of various mercaptoorganylsilanes. First, these compounds are not available commercially and must be synthesized in-house by complex synthesis procedures. Second, they tend to spontaneous condensation and therefore do not create pure monolayers on the surface of the nanoparticles. Formation of multiple layers is a disadvantage because in the subsequent processing of the particles (for example, in hot melts) the organic components should be present in the smallest possible amount because they are less stable with respect to heat/mechanical loads, etc. and may result in gas bubbles and/or inhomogeneities in the metal matrix.

Furthermore, organylsilanes and/or the oligomers formed by spontaneous condensation do not bind chemically to the surface of transition metal carbides, as has been demonstrated by infrared spectroscopic measurements.

In addition, another disadvantage of this invention is that only the functionalization of particles in the nano size range is described. Furthermore, the possibility that ormocere (organically modified ceramic) and other oligomeric species of the organylsilane are not separated completely and therefore are also coated with metal. These metal-coated ormoceres also have a high organic content, which can have negative effects on introduction into the metal melt.

Mondin et al. have proven that SiO₂ and Al₂O₃ particles modified with mercaptosilanes such as (3-mercaptopropyl)triethoxysilane (MPTES), for example, which are then coated with copper, for example, do not have pure monolayers [G. Mondin et al. Electrochimica Acta 114, 2013, 521-526].

The phosphonates, phosphoric acid esters and/or carboxylic acids in dilute aqueous systems do not have a tendency to spontaneous condensation so excess phosphonate, phosphoric acid esters and/or carboxylic acid can easily be removed and recycled if necessary.

Si et al. and Zhou et al. describe Fe₃O₄ nanoparticles coated with polydopamine [J. Si, H. Yang, Mater. Chem. Phys. 128 (2011) 519, W.-H. Zhou, C.-H. Lu, X.-C. Guo, F.-R. Chen, H.-H. Yang, X.-R. Wang, J. Mater. Chem. 20 (2010) 880].

Li et. al. describe Fe₃O₄ particles coated with polydopamine and also coated with silver [Q. Li, M. Tian, L. Liu, H. Zou, L. Zhang, W. C. Wang, Electrochim. Acta 91 (2013) 114].

Wang et al. describe coating of 25 μm silicon dioxide particles with polydopamine and silver [W. Wang, Y. Jiang, Y. Liao, M. Tian, H. Zou, L. Zhang, J. Colloid Interface Sci. 358 (2011) 567].

Mondin et al. describe a process for currentless metal deposition on polydopamine-functionalized nano- and microparticles. First both WC microparticles (0.1-100 μm particle diameter) and Al₂O₃ nanoparticles (0.1-100 nm particle diameter) were functionalized with polydopamine. Silver or copper was successfully deposited on the polydopamine-functionalized WC particles. The polydopamine-functionalized Al₂O₃ particles were then successfully coated with copper [G. Mondin et al., J. Colloid Interface Sci. 411 (2013) 187].

In functionalization of the particles by means of polydopamine, it is also a disadvantage that no monolayer can be obtained. The formation of multiple layers and thus the comparatively numerous organic constituents on the particle surface is again a disadvantage for future processing (for example, in hot melts). The greater the amount of organic constituents, the more gaseous degradation products may be formed on introduction into the melt, which can cause splashing of the metal coating.

Metal-coated inorganic particles are important for use in metal-matrix composites. With the help of the metal-coated inorganic particles, the properties of the metal matrix can be improved in a targeted manner depending on the field of application.

Uncoated inorganic particles have completely different surface properties than the metal matrix into which they are to be incorporated. On introduction of the uncoated inorganic particles into the metal matrix, agglomeration of the inorganic particles and/or formation of air bubbles and other inhomogeneities in the matrix usually occur.

However, metal-coated inorganic particles have different surface energies, which are more like those of the metal matrix, which is why they can be incorporated better.

The functionalization of inorganic particles, in particular in carbide form, is very challenging for currentless metal coating because these particles are chemically inert.

It is the object of the invention to provide a process for amine functionalization of surfaces of inorganic particles, which can then be provided with a metal layer by means of currentless deposition techniques. To minimize the organic components in the metal-coated particles, the organic intermediate layer should preferably be applied as a monolayer.

This object is achieved by a process for producing metal-coated inorganic particles by means of currentless deposition techniques comprising the process steps:
a) functionalization of inorganic particles,
b) introducing the functionalized inorganic particles into an aqueous metal salt solution containing metal ions,
c) adding a reducing agent to the aqueous metal-salt mixture containing the functionalized particles to reduce the metal ions and to deposit a metal on the functionalized particles,

wherein the functionalization of the particles according to process step a) with an aminophosphonic acid, an aminocarboxylic acid and/or an aminoalcohol phosphoric acid ester takes place in such a way and wherein the aminophosphoric acid, the aminocarboxylic acid and/or the aminoalcohol phosphoric acid ester form a monolayer on the surface of the inorganic particles.

The particles are amine functionalized to promote the deposition of various metals on the surface.

The inorganic particles for functionalization with an aminophosphonic acid, an aminocarboxylic acid (also referred to as an amino acid) and/or an aminoalcohol phosphoric acid ester are preferably treated with a 2- to 1000-fold excess, especially preferably with a 4- to 100-fold excess, most especially preferably with a 5- to 10-fold excess, based on the amount of substance required to form a monolayer.

The amount of substance required to form a monolayer can be calculated from the amount of space required for the functional group (phosphate) that binds to the surface as approximately 4.2 nm²/molecule and the specific surface area of the particles [C. J. Lomoschitz et al., Langmuir, 27 (2011) 3534].

Aminophosphonic acid of the general empirical formula H₂PO₃—(CR₂)n-NH₂, where n is at least 1, where the radicals R, independently of one another, are selected from preferably a hydrogen atom or an alkyl chain of any length which may contain additional (amine) functionalities are preferred as the aminophosphonic acids. According to the invention any length of the alkyl chain means that it preferably consists of 1 to 10 carbon atoms, especially preferably 2 to 5 carbon atoms and most especially preferably —CH₂—CH₂—, —CH₂CH₂—CH₂—, —CH₂—CH₂—CH₂—CH₂—. The aminophosphonic acid may also be selected from the group of aminobisphosphonic acids.

The aminocarboxylic acids are preferably selected from aminocarboxylic acids of the general structure HOOC—(CR₂)ₙ—NH₂ where n is at least 1, wherein the radicals R, independently of one another, are selected from preferably a hydrogen atom or an alkyl chain of any length that may contain additional (amine) functionalities. According to the invention, any length of the alkyl chain means that it preferably consists of 1 to 10 carbon atoms, especially preferably 2 to 5 carbon atoms, and most especially preferably —CH₂—CH₂—, —CH₂—CH₂—CH₂—, —CH₂CH₂—CH₂—CH₂—.

The preferred aminoalcohol phosphoric acid esters are aminoalcohol phosphoric acid esters of the general structure H₂₋ₓPO₃₋ₓ—(O(CR₂)nNH₂)ₓ₊₁ where n is at least 1, where the R radicals independently of one another are selected from preferably a hydrogen atom or an alkyl chain of any length which may contain additional (amine) functionalities. According to the invention any length of the alkyl chain means that it preferably consists of 1 to 10 carbon atoms, especially preferably 2 to 5 carbon atoms and most especially preferably —CH₂—CH₂—, —CH₂—CH₂—CH₂—, —CH₂—CH₂—CH₂—CH₂—. Preferably x is 0 to 2, especially preferably 0 to 1 and most especially preferably x is 0.

In the functionalization with aminophosphonic acids, aminocarboxylic acids and/or aminoalcoholphosphoric acid esters, a monolayer is surprisingly formed on the surface of the particle, which is particularly advantageous for a subsequent application of the inorganic particles. Monolayers according to the invention refer to the presence of a layer of molecules on the surface, wherein the layer thickness does not exceed one molecule. According to the invention monolayers of aminophosphonic acids, aminocarboxylic acids and/or aminoalcohol phosphoric acid esters are formed on the inorganic particles. The layer thickness of the monolayers of aminophosphonic acids, aminocarboxylic acids and/or aminoalcoholphosphoric acid esters does not exceed the length of one molecule. In processing the metal-coated inorganic particles, for example, in a hot melt, it is advantageous if the amount of organic constituents on the inorganic particles is minimized because these are less stable with respect to high temperatures and mechanical loads. There is advantageously no spontaneous condensation of the individual molecules with one another when using phosphonic acids, carboxylic acids and phosphonic acid esters, which would result in a layer with an irregular layer thickness being formed on the particles, as is known, for example, from the prior art in functionalization with silanes.

The inorganic particles are preferably selected from ceramics or carbon particles, especially preferably from oxidic particles or carbidic particles, most especially preferably from WC, Al₂O₃, SiO₂. The inorganic particles may assume approximately spherical to spherical-shaped but agglomerated inorganic particles and nanorods are also included. The carbon particles may be present, for example, in the form of nanotubes, fullerenes or graphenes.

The inorganic particles preferably have a size of 0.1 mm (nanoparticles) to 100 μm (microparticles).

The nanoparticles preferably have a size of 1 to 50 nm, most especially preferably from 10 to 20 nm.

The microparticles preferably have a size of 1 to 50 μm, most especially preferably from 1 to 5 μm.

Before functionalization of the inorganic particles (process step a) on the particle surface, hydroxide groups are preferably generated by means of an activation reagent. Preferably nonoxidic particle surfaces are treated with an activating reagent before the amine functionalization. The activating reagent is preferably selected from acids, especially preferably from mineral acids, most especially preferably from HCl, HBr, HI, HF, H₂SO₄ and HNO₃. Molecular oxygen or ozone may preferably be used as the activating reagent.

The functionalization of the inorganic particles after process step a preferably takes place at temperatures of 10 to 40° C., especially preferably of 15 to 30° C., most especially preferably from 20 to 25° C., even more preferably at room temperature.

The aqueous metal-salt solution containing metal ions preferably contains at least one metal salt of a metal selected from Ni, Cu, Co or metals of groups 5, 6, 7, 8, 13, 14 and 15 of the periodic system of elements. The coating on the amino-functionalized particle surfaces is preferably applied by reducing a metal of the metal salts or multiple metals of the metal salts from an aqueous solution and then depositing the metal or metals on the amine-functionalized particle surface. The metal-salt solution preferably contains mixtures of different metal salts with different metals which preferably have a similar redox potential. A similar redox potential according to the invention means that the different metals in the metal-salt solution can be reduced using the same reducing agent.

When introducing the functionalized inorganic particles into an aqueous metal-salt solution according to process step b, complexing agents are preferably also used. The complexing agent is preferably selected from ethylenediaminetetraacetic acid (EDTA), citric acid and salts thereof, sodium methylenediamine tetraacetate, trieethylenediamine or ethylenediamine. Depending on the inorganic particles used, the reagent for amine functionalization and the type of metal-salt solution, those skilled in the art will select the suitable complexing agent. Use of the complexing agents facilitates the deposition of the metal on the particle surface, while preventing pure metal from the metal salt from being deposited.

The reducing agent is preferably selected from hydrazine, sodium borohydride, hypophosphite or hydrogen.

The reducing agent is preferably used with an excess of a 5-fold to 100-fold amount of substance of the metal salt to be reduced, especially preferably with an excess of 10-fold to 50-fold the amount of substance of the metal salt to be reduced. Preferably 90% of the metal-salt solution, especially preferably more than 99% of the metal-salt solution is reduced, most especially preferably the entire metal-salt solution is reduced.

Metal complexes are formed through the choice of a suitable complexing agent. In this way the redox potential can be adjusted very precisely. Reducing agents whose redox potential is negative enough to reduce the metal cation from the respective metal complex are preferably used for this reduction. Reducing agents with a redox potential of −1.57 to −1.11V are preferably used for this reduction; in the case of Cu the reducing agents preferably have a redox potential of −1.20 to −1.10V, especially preferably hydrazine; in the case of Ni, Co, Cr, Sn, Pb, Sb, Bi, Zn, Cu, Fe, Al or mixtures of these elements, reducing agents with a redox potential of −1.57 to −1.24V, especially preferably sodium borohydride or a mixture of sodium borohydride with a reducing agent having a redox potential of −1.57 to −1.11V is preferably used.

Currentless deposition of the respective metals preferably takes place by means of the respective reducing agents, complexing agents and temperatures summarized in the following table but should not be limited to these:

| Coating | | Complexing | |
|---|---|---|---|
| metal | Reducing agent | agent | Temperature |
| copper | hydrazine (N₂H₂) | EDTA | room |
| (Cu) | | | temperature |
| nickel | sodium borohydride | EDTA | room |
| (Ni) | (NaBH₄) | | temperature |
| | hypophosphite | | |
| cobalt | sodium borohydride | sodium citrate | 60° C. |
| (Co) | (NaBH₄), | | |
| | sodium hypophosphite | | |
| | Na(H₂PO₂) | | |
| silver | potassium sodium tartrate | ethylenediamine | room |
| (Ag) | (KNaC₄H₄O₆) | | temperature |

The metal-coated inorganic particles are suitable in particular for use in metal-matrix composites because of the modified surface properties.

Metal-matrix composites according to the invention are metallic composite materials consisting of a matrix made of at least one metal plus the inventive metal-coated nonmetallic particles.

The process described in the invention permits exclusive formation of monolayers in amine functionalization of the particle surface; such monolayers are especially advantageous for future use of the inorganic particles. In processing the metal-coated inorganic particles in hot melt baths, for example, it is advantageous if the amount of organic constituents on the inorganic particles is minimized because they have a lower stability with respect to high temperatures and mechanical loads. The use of aminophosphonic acids, aminocarboxylic acids and/or aminoalcohol phosphoric acid esters to form monolayers is thus particularly advantageous in comparison with the possibilities known in the past for functionalizing the surface for currentless metal deposition, such as functionalization of the particles by means of silane-based thiols, for example (WO 2012/072658 A2) or polydopamine [G. Mondin et al., J. Colloid Interface Sci. 411 (2013) 187].

It is also advantageous that the aminophosphonic acids, aminocarboxylic acids and/or aminoalcohol phosphoric acid esters are stable in storage for a much longer period of time. In comparison with that, the mercaptoorganyl silanes described in WO 2012/072658 A2 for functionalization of the particles are not stable in storage because they have a tendency to spontaneous condensation.

It is also advantageous that the deposition of the metals can preferably take place at room temperature while the functionalization by means of mercaptoorganyl silanes takes place only at elevated temperatures.

### EXEMPLARY EMBODIMENTS

Based on the diagrams shown and the exemplary embodiments, the invention will now be explained in greater detail without limiting it to these examples, where the figures show:

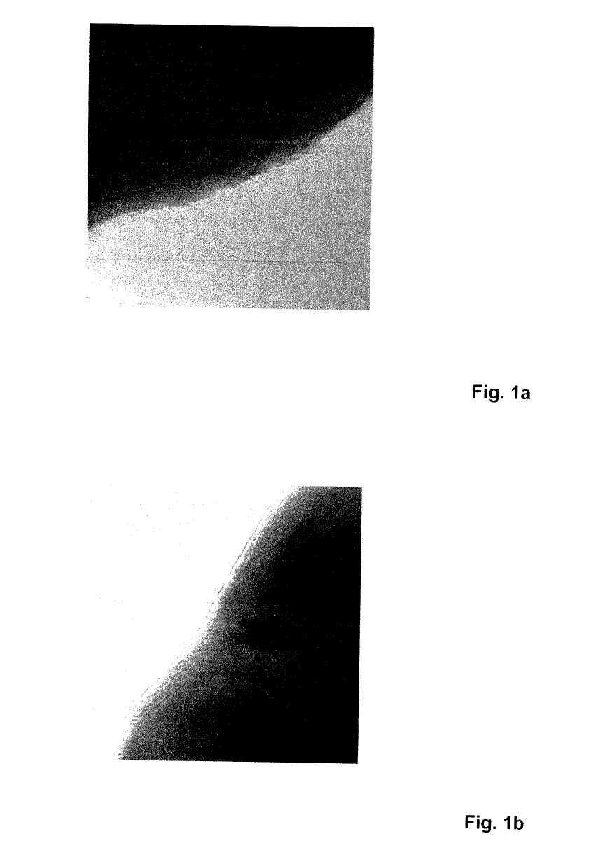

FIG. 1: TEM micrographs (transelectron microscopy) of nano-WC particles without amine functionalization (FIG. 1a) and nano-WC particles functionalized with 3-aminopropylphosphonic acid (3-APP) (FIG. 1b).

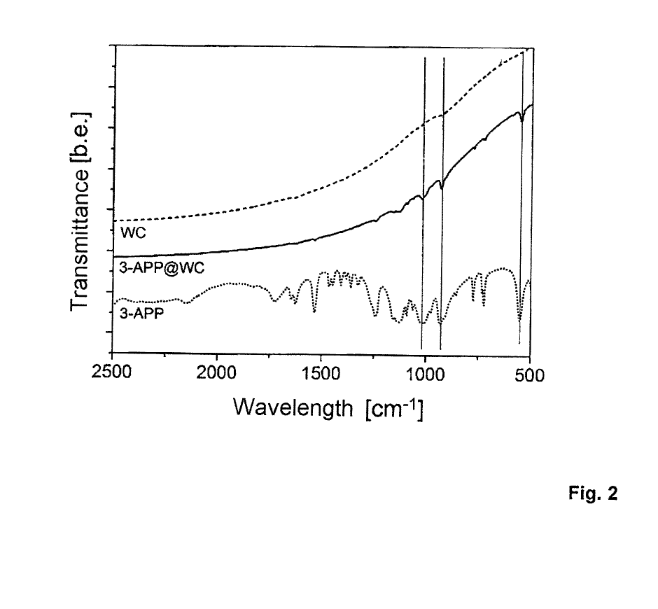

FIG. 2: IR spectra of 3-aminopropylphosphonic acid (3-APP), uncoated micro-WC particles and micro-WC particles treated with 3-am inopropylphosphonic acid (3-APP@WC).

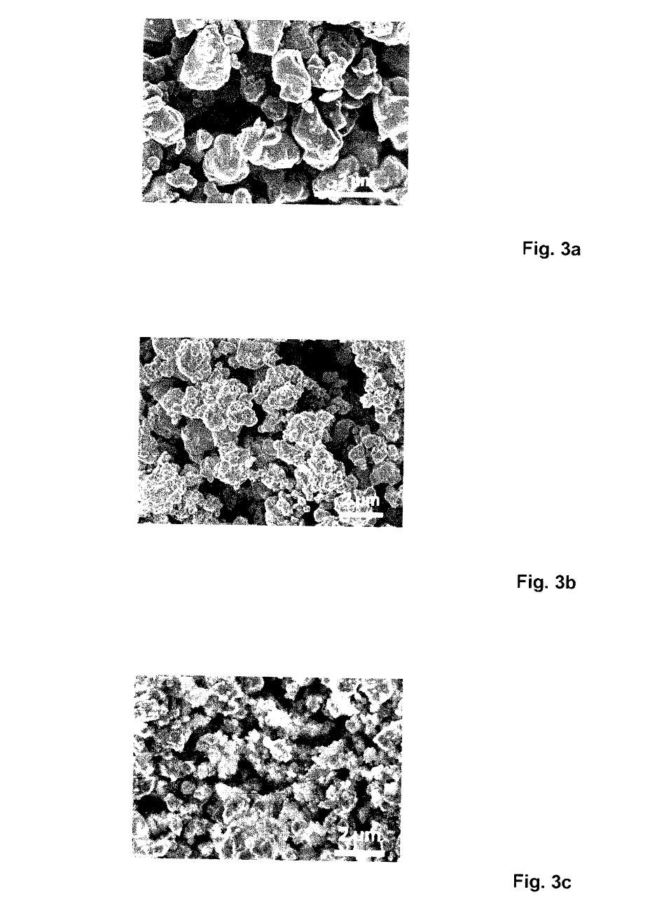

FIG. 3: SEM micrographs (scanning electron microscopy) of untreated and uncoated WC particles, of WC particles after copper deposition and a WC particle after nickel deposition.

### 1) FUNCTIONALIZATION OF WC PARTICLES BY MEANS OF 3-AMINOPROPYLPHOSPHONIC ACID (3-APP)

Tungsten carbide particles (WC, 1 μm) were dispersed in hydrochloric acid and stirred for 1 h at room temperature. After activation, an excess of 3-aminopropylphosphonic acid (3-APP), (5.10⁻³ M) was added to 20 g/L tungsten carbide particles in deionized water and stirred for 24 h. Excess 3-APP was centrifuged out and the functionalized particles were washed several times with water and ethanol and then centrifuged again. The resulting particles were dried in vacuo at 40° C. FIG. 1 shows TEM micrographs (transmission electron microscopy) of nano-WC particles without amine functionalization (FIG. 1a) and of nano-WC particles functionalized with 3-aminopropylphosphonic acid (3-APP) (FIG. 1b). With the help of this process, the amine functionalization of the particle surface can be investigated. FIG. 1b shows clearly that a monolayer of 3-APP has been formed on the nano-WC particle surface by functionalization by means of 3-APP.

In addition, it can be demonstrated by means of IR measurement (infrared spectroscopy) that the 3-aminopropylphosphonic acid does in fact bind to the particle surface for amine functionalization. FIG. 2 shows the IR spectra of 3-aminopropylphosphonic acid (3-APP) as a reference and uncoated micro-WC particles (WC) in comparison with micro-WC particles treated with 3-aminopropylphosphonic acid (3-APP@WC), in which it can be seen clearly that 3-APP has been applied to the WC particles.

### 2) COPPER DEPOSITION ON 3-APP-FUNCTIONALIZED WC PARTICLES

Currentless deposition of copper on WC particles coated with 3-APP was carried out from an aqueous solution containing 7.5 g/L copper sulfate pentahydrate, 5.5 g/L sodium methylenediamine tetraacetate and 10 g/L WC particles. The particles were dispersed by ultrasonic treatment (5 min) and then 18.5 mL/L hydrazine hydrate solution (˜80%) was added. After about 2 h (end of the rele3ase of gas), the excess hydrazine was deactivated with hydrogen peroxide, the particles were first decanted, then washed with water and ethanol and centrifuged until the wash water was colorless. The resulting particles were dried in vacuo at 40° C. The inorganic particles on which copper had been deposited could be examined by means of SEM (scanning electron microscopy). FIG. 3a shows a WC particle which is not amine-functionalized and has not been coated; FIG. 3b shows a WC particle after deposition of copper. The deposition of metal was detected morphologically on the copper-coated particles.

### 3) DEPOSITION OF NICKEL ON 3-APP-FUNCTIONALIZED WC PARTICLES

Currentless deposition of nickel on WC particles coated with 3-APP was carried out from an aqueous solution containing 10 g/L nickel(II) chloride hexahydrate and 10 g/L WC particles. The particles were dispersed by means of an ultrasonic treatment (5 min) and then 3.4 g/L sodium borohydride was added. After successful coating, the particles were first decanted until the wash water was loaded. The resulting particles were dried at in vacuo 40° C.

The particle coated in this way contained 42% by weight nickel.

The inorganic particles on which nickel was deposited can be examined by means of SEM (scanning electron microscopy). FIG. 3a shows a WC particle which is not amine functionalized and is not coated. FIG. 3c shows a WC particle after nickel deposition. The metal coating is detected morphologically on the nickel-coated particles.

### 4) ALTERNATIVE NICKEL DEPOSITION ON 3-APP-FUNCTIONALIZED WC PARTICLES

Currentless deposition of nickel on WC particles coated with 3-APP was carried out from an aqueous solution containing nickel(II) chloride hexahydrate, 16 g/L sodium methylenediamine tetraacetate, sodium borohydride and WC particles. The particles were dispersed by an ultrasonic treatment for 5 min. After successful coating, the particles were first decanted, then centrifuged and washed with water and ethanol and centrifuged until the wash water was colorless. The resulting particles thereby obtained were dried in vacuo at 40° C.

The particles coated in this way contained 20% by weight nickel.

The nickel-coated particles were examined by SEM according to Example 3. Nickel deposition is also morphologically detectable on these particles.

The metal-coated inorganic particles can be evaluated visually with regard to color. The untreated inorganic particles range in color from white to anthracite to brown, but they are black in color after deposition of the metal (Co, Ni).

1. A process for producing metal-coated inorganic particles by means of currentless deposition technique using the following process steps:
a) functionalization of the inorganic particles,
b) introducing the functionalized particles into an aqueous metal-salt solution containing metal ions,
c) adding a reducing agent to the aqueous metal-salt mixture containing the functionalized particles for reduction of the metal ions and deposition of a metal on the functionalized particles,
characterized in that the functionalization of the particles according to process step a) takes place with an aminophosphonic acid, an aminocarboxylic acid and/or an aminoalcohol phosphoric acid ester, wherein the aminophosphonic acid, the aminocarboxylic acid and/or the aminoalcohol phosphoric acid ester form(s) a monolayer on the surface of the inorganic particles.

2. The process according to claim 1, characterized in that the inorganic particles are selected from ceramics or carbon particles.

3. The process according to claim 1, characterized in that the inorganic particles are from 0.1 to 100 μm in size.

4. The process according to claim 1, characterized in that hydroxide groups are generated by means of an activating reagent before functionalization of the inorganic particles on the particle surface.

5. The process according to claim 1, characterized in that the functionalization of the inorganic particles takes place at temperatures in the range of 10 to 40° C.

6. The process according to claim 1, characterized in that the aqueous metal-salt solution contains at least one metal salt of a metal selected from Ni, Cu, Co or metals of the groups 5, 6, 7, 8, 13, 14, 15 of the periodic system of elements.

7. The process according to claim 1, characterized in that a complexing agent is also used in introducing the functionalized inorganic particles into an aqueous metal-salt solution.

8. The process according to claim 1, characterized in that the reducing agent is selected from hydrazine, sodium borohydride, hypophosphite or hydrogen.

9. Metal-coated inorganic particles produced by a process according to claim 1.

10. A metal-matrix composite comprising a matrix made of at least one metal plus the metal-coated inorganic particles produced according to a process according to claim 1.

11. The metal-coated inorganic particles according to claim 9, characterized in that the inorganic particles are selected from ceramics or carbon particles.

12. The metal-coated inorganic particles according to claim 9, characterized in that the inorganic particles are from 0.1 to 100 μm in size.

13. The metal-coated inorganic particles according to claim 9, characterized in that hydroxide groups are generated by means of an activating reagent before functionalization of the inorganic particles on the particle surface.

14. The metal-coated inorganic particles according to claim 9, characterized in that the functionalization of the inorganic particles takes place at temperatures in the range of 10 to 40° C.

15. The metal-coated inorganic particles according to claim 9, characterized in that the aqueous metal-salt solution contains at least one metal salt of a metal selected from Ni, Cu, Co or metals of the groups 5, 6, 7, 8, 13, 14, 15 of the periodic system of elements.

16. The metal-coated inorganic particles according to claim 9, characterized in that a complexing agent is also used in introducing the functionalized inorganic particles into an aqueous metal-salt solution.

17. The metal-coated inorganic particles according to claim 9, characterized in that the reducing agent is selected from hydrazine, sodium borohydride, hypophosphite or hydrogen.
